(19) United States
(12) Patent Application Publication
(10) Pub. No.: US 2009/0083495 A1
(43) Pub. Date: Mar. 26, 2009

(54) MEMORY CIRCUIT WITH ECC BASED WRITEBACK

(76) Inventors: Muhammad M. Khellah, Tigard, OR (US); Dinesh Somasekhar, Portland, OR (US); Vivek K. De, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/861,298

(22) Filed: Sep. 26, 2007

(51) Int. Cl. G06F 12/00

(52) U.S. Cl. 711/143; 711/E12.001

(57) ABSTRACT

Provided herein are circuits incorporating a dynamic technique to minimize power overhead with writeback. In some embodiments, error-correction-code (ECC) is used to dynamically detect bit failures and use that information to identify memory sub-sections to be enabled for writeback.

### TECHNICAL FIELD

Embodiments disclosed herein relate generally to integrated circuit (“IC”) devices and in particular to memory circuits.

### BACKGROUND

Memory formed from arrays of static random access memory (“SRAM”) cells are commonly used in many different applications. Such arrays are typically configured into multiple columns of cells with each column of cells sharing a common bit line there many different types of SRAM cells such as so-called 4T and 6T cells an example of a 6T cell is shown in FIG. 1.

FIG. 1 shows a conventional 6T bit cell 102. (As used herein, a “bit cell” refers to any suitable device or device combination for implementing a memory cell coupled to a dischargeable bit line or bit line pair.) The depicted bit cell 102 is a so-called 6T SRAM cell, which is a complementary-output (outputs C, C#) static random access memory (“SRAM”) cell. It comprises pull-up transistors M1, M2, pull-down transistors M3, M4, access (or gate) transistors M5, M6, a word-line node (WL[I]), and an associated bit line pair (BL, BL#) coupled as shown.

The pull-up and pull-down transistors M1 to M4 are coupled to form a cross-coupled inverter pair having internal, complementary storage nodes (C and C#). The complementary storage nodes (C, C#) are controllably coupled, respectively, to the bit line nodes (BL, BL#) through gate transistors M5 and M6. During a precharge state, when both access transistors M5, M6 are turned off, the bit lines, BL, BL#, are charged High.

Depending on the state of the cell, i.e., whether it is storing a ‘1 or a ‘0, a Low level will be at either the C or C# storage node, and a High will be at the other storage node. When the cell is to be read, the word-line node (WL) is asserted (High) turning on gate transistors M305 and M306, which discharges the bit line node (BL or BL#) that is coupled to the Low storage node (C or C#). This state (or value) on the bit line is typically then “read” by a sense amplifier coupled to the bit line. When a value is to be written into the cell, the reverse occurs. The sense amplifier places onto the bit line (lines BL, BL#) a desired value, the access transistors M5, M6 are turned on by the word line, and the value is written into the cell.

Unfortunately, with ever decreasing transistor dimensions, operational parameter mismatch (e.g., threshold voltage mismatch) between neighboring transistors is exacerbated, resulting in greater cell instability during read and/or write operations. Read stability is the ability of a cell to retain its contents during a read operation. Write stability is the ability to accurately write a value into a cell. There have been different approaches to address cell instability. For example, in some prior solutions, wider supply voltage levels, e.g., negative low reference levels during read operation, are provided to sensitive cells or cell groups. This approach is generally disfavored, however, because making additional supplies available can be costly and increase power consumption.

With other approaches, the relative sizes of pull-up, pull-down, and/or access transistors are weighted to favor read or write operations. This approach too, however, has drawbacks. Typically, by improving read stability, one reduces write stability and visa versa.

Another approach is known as memory writeback. This approach involves writing data back into a cell after it has been read. The basic idea is to allow the cell to be unstable and upon a read operation, the cell value is read using a per-column sense-amplifier and then written back to correct for any possible flipping. Thus cell failure criterion depends on the cell's inability to develop enough differential before it actually flips. This is a looser condition than conventional cell failure criterion which considers a cell bad if it flips during access. In essence, the read operation is allowed to be destructive. An advantage of this is that with writeback, read cell ratio is of lesser importance and thus, a unity beta ratio (the ratio between the pull-up and pull-down transistor sizes) can be employed. This allows for all of the transistors in a cell to be equally sized, e.g., with minimum geometry resulting in several advantages including notch-free diffusion layout and better write-ability due to lower trip points.

A drawback with this technique is that it can be fairly costly from a processing and power consumption standpoint. Typically, a per column sense-amplifier is turned on for every access (read or write). As a result, excessive power is consumed to write-back all columns, e.g., on a wordline, during read operations.

Another approach that improves on this involves writing back to limited areas of memory. Healthy portions of memory are masked to avoid writeback so that writeback is only enabled for areas having bad cells. With such approaches, it appears that bad cells to have writeback are identified in a static fashion, e.g., during the manufacturing process where the flags (masks) are programmed (fused) into a chip. Unfortunately, this is not flexible and may be costly.

Accordingly, an improved approach for addressing read and/or write instability in SRAM is desired.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a schematic diagram of a conventional 6T SRAM cell.

FIG. 2 is a schematic diagram of an SRAM memory with ECC writeback in accordance with some embodiments.

FIG. 3 is a diagram of a memory array from the memory shown in FIG. 2, in accordance with some embodiments.

FIG. 4 is a diagram of a cell column suitable for use with the array shown in FIGS. 2 and 3.

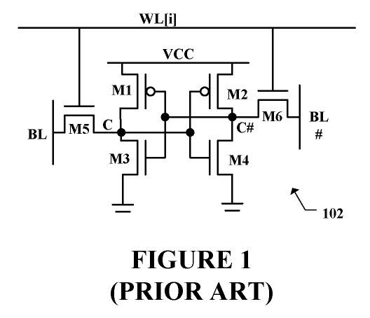

### DETAILED DESCRIPTION

In this disclosure, a dynamic technique to minimize power overhead with writeback is disclosed. In some embodiments, error-correction-code (ECC) is used to dynamically detect bit failures and use that information to identify memory sub-sections to be enabled for writeback.

ECC is commonly used in cotemporary embedded memory (e.g., last level cache) to detect and correct for soft errors, which can cause a cell to flip its contents if the cell is hit, e.g., by sigma or cosmic particles. Single-error-correction-double-error-detection (SECDED) is typically used due to its low cost. With double error detect, single error correct, once ECC detects an error in a given memory block, it typically corrects the error (if it is a single bit error) or reports it if it is a 2-bit error. With either ECC cases, the address of the culprit bit may be reported, e.g., so that the cell can be bypassed.

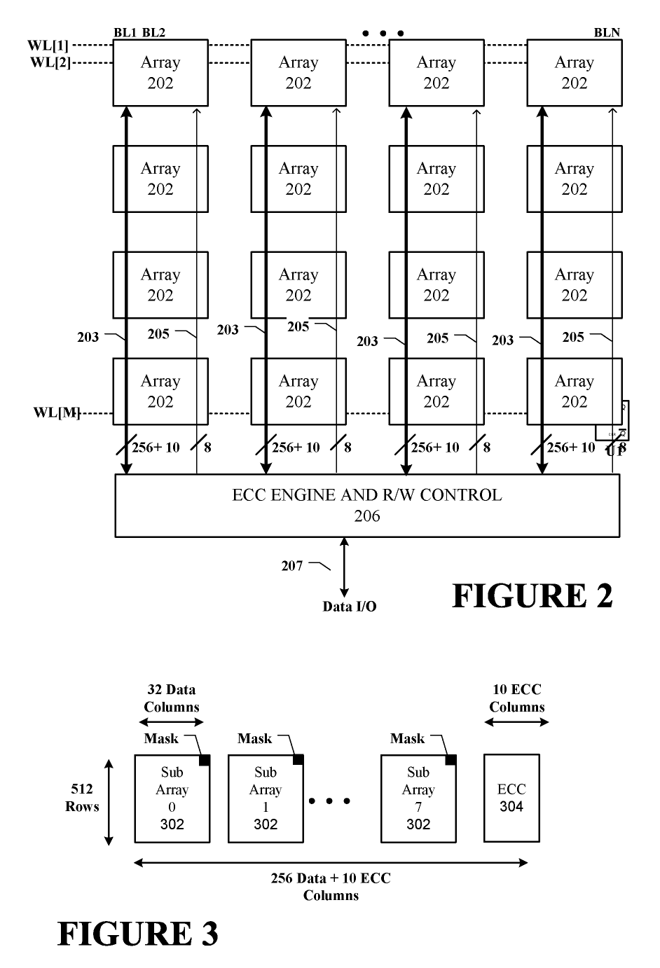

FIG. 2 shows a an SRAM memory (e.g., cache) comprising M by N (2024×1024 in the figure) data cells organized into 16 memory arrays 202. It also has 256-bit data busses 203 and 10-bit ECC busses 205, ECC engine and control circuit 206, and a data I/O bus 207.

There are M word lines (WL[1] to WL[M]) coupled to rows of cells in the arrays for accessing a row of cells across the memory section. Each array 202 has 256 data columns and 10 ECC columns coupled, respectively, to the data busses 203 and ECC busses 205, as shown. In addition, each array has 512 rows of bit cells. Thus, the depicted memory section with its 4×4 matrix of arrays 202 defines a 2048×1024 matrix of data bit cells with 512 rows of 40 ECC bit cells, 10 ECC bits per row per array. Thus, in this depiction, each array 202 comprises its own segment (10 bits per line) of ECC bits for identification of an errant bit cell in its associated row in an array.

When data is to be written into a row of data cells, it is conveyed to the ECC engine and control circuit 206 via the data I/o bus 207. The ECC engine processes the received data and calculates the ECC bits, either for a specified array or for the entire row if each array in a row is to be written. The appropriate word line is selected, the received data is written into the corresponding row of cells (in an array or entire row), and the calculated ECC data (10 bits per array) is written into the ECC cells for the row. (Data may be written into a single array via a single data bus 203 and ECC bus 205, or it may be written into a number of arrays via a number of data busses 203 and ECC busses 205.)

A similar process, but in reverse order, is generally performed for a read operation. A wordline is selected, and data from that row is transmitted to the data busses 203 and then to the data I/O bus 207 via the control circuit 206. All cells on the line may be read or a so-called “dummy read” may be performed where selected columns are actually read and transferred to the data I/O bus 207 with the other column's cells read without the data actually being conveyed. When the data is read, it is also written back into the cells that have been flagged for writeback. In addition, when data is read, the ECC engine also checks the read data against the ECC data to determine if new portions (sub-arrays) in an array have errant bits. If so, they are then flagged for writeback.

In some embodiments, writeback may be implemented for write operations, especially if only a portion of a row is written. This is so because the activated word line may lead to data being lost in the cells on the line not actually written. Generally speaking, for writeback, data from cells in a selected row is read from and written back into the cells. As addressed in more detail below, this is controlled by the ECC/control circuitry 206. It controls data, on a selected word line in one or more arrays designated for writeback, to be read from and written back into the selected cells.

(It should be appreciated that any suitable circuit or combination of circuits can be used to implement the memory including the ECC engine and control circuitry. For simplicity and ease of understanding, separate control and timing blocks are not shown since control and timing of SRAM cells to perform read and write operations, as well as to implement writeback, are well known in the art.)

FIG. 3 shows a block diagram of an array 202 for the memory section of FIG. 2 in accordance with some embodiments. It comprises eight data sub-arrays 302 and an ECC block 304. The sub-arrays and ECC block each have 512 rows (wordlines) of cells, with 32 columns of data cells in each sub-array 302 and 10 columns of ECC cells in the ECC block 304. Thus, there is a total of 256 data columns of data cells and 10 columns of ECC cells in each sub-array. Each sub-array also has a mask bit to prevent it from having writeback if it doesn't have an errant cell in the entire sub-array (or alternatively, to flag it to receive writeback if it has an errant bit cell). Thus, in this embodiment, writeback is applied only to sub-arrays in the memory of FIG. 2 with one or more errant cells. (Note that “flags {“as used herein, may indicate that a sub-array or other portion of memory is to be enabled for writeback or alternatively, is to avoid writeback.}

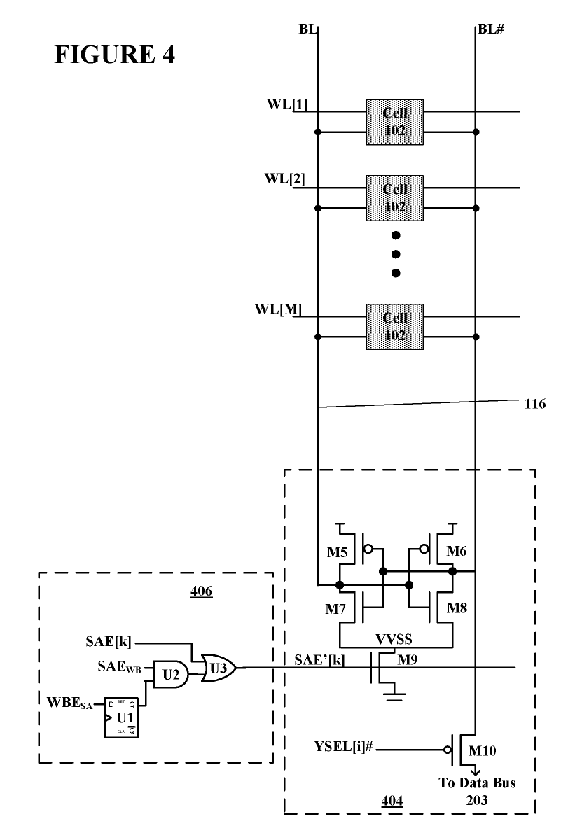

FIG. 4 shows an exemplary column of bit cells for an array 202 (an array from the first row of arrays) from the memory section of FIG. 2. It has 512 cells 102 and a sense amplifier circuit 404 coupled to a bit line formed from a complementary bit line pair (BL, BL#) and writeback mask circuitry 406 coupled to the sense circuitry 404 (from the ECC engine). (It also comprises a precharge circuit, not shown).

The sense amplifier comprises transistors M5 to M9, along with access transistor M1, coupled together as shown. When the sense amp. enable signal (SAE′[k]) is asserted, M9 turns on to activate the sense amplifier. When activated, the sense amplifier can capture the value (state) on the bit line upon a read operation or write a value onto the bit line upon a write operation. The value on the bit line can be conveyed to a bit line in the data bus 203 when the column decode signal (YSEL[i]#) is asserted to turn on access transistor M10. Conversely, when data is to be written into a bit cell on the column, it is written into the sense amplifier 404 via access transistor M10 and from there, into a selected cell (via its wordline) through the bit line (BL, BL#).

The writeback mask circuit 406 comprises a D-type flip flop (or latch) U1, an AND gate U2, and an OR gate U3, coupled to the access transistor M9 as shown. The AND gate's output is coupled to an input of the OR gate, whose output (SAE′[k]) is coupled to the gate of M9 to control it. A writeback enable signal (WBE), latched through U1, is applied to one of the AND gate inputs. The other input is provided by a writeback sense amp. enable signal (SAE_{WB}). If the column is part of a sub-array with a bad cell, then the WBE will assert (high), thereby enabling the SAE_{WB} signal to activate the sense amp. 404, via OR gate U3, during a writeback operation. On the other hand, if the sub-array has no bad cells, then SAE_{WB} will be low, causing the AND gate output to stay de-asserted even as SAE_{WB} is asserting.

The other input to the OR gate comes from a sense amp. enable signal (SAE[k]) for read/write operations. This signal controls the sense amplifier to implement actual read and write operations to transfer data between the bit cells and the data I/O bus 207. (it should be appreciated that other ways to implement how memory portions are to be controlled, e.g., for enabling writeback, may be employed and are within the scope of the invention.)

In operation, when data is written into a block of cells, e.g., a wordline of cells in a sub-array, array or arrays, the data is conveyed to the ECC control block 206 via the data I/O bus 207. It is processed by the ECC engine portion to determine (or update) ECC bit values for the 10 ECC bits in each array. The data is then written into the appropriate portion of wordline of data cells via a data bus(ses) 203, and the ECC data is written into appropriate ECC cells via an ECC bus(ses) 205. During the write operation, writeback may be performed for the sub-array(s), on the same activated wordline not to have new (data from data I/O) data written into it, whose SAE_{WB} signals are asserted. For the actual write operation, the SAE[k] signal is used, but for the writeback operation, the SAE_{WB} signal is used.

For a read operation, data is read from a selected wordline of memory cells via one or more data bus(ses) 203, with the SAE[k] signal used to activate the appropriate sense amplifiers. At the same time, the ECC data from the read sub-arrays are also read (via ECC busses 205) and processed by the ECC engine portion of block 206 to determine if there any errant cells. If so, then WBE signals for sub-array(s) having errant cells are asserted and latched so that writeback will be performed on them in the future. Up-on reading of the data, writeback is performed on the sub-array portions whose WBE signals have been asserted. For writeback, the SAE_{WB} signal (separate one for each sub-array in this embodiment) is used.

With embodiments discussed herein, read-stable cache is provided with power savings through out the life of the cache by accounting for voltage and temperature changes, gate oxide (erratic-bit) changes, and PMOS NBTI changes, to mention just a few. This approach provides for dynamic read and write stability improvement with lower power consumption.

While the inventive disclosure has been described in terms of several embodiments, those skilled in the art will recognize that the invention is not limited to the embodiments described, but can be practiced with modification and alteration within the spirit and scope of the appended claims. For example, while the discussed embodiments used bit cell columns with complementary bit line pairs, other embodiments could use different bit line configurations such as those with a single dischargeable bit line, depending upon a particular technology or application. Likewise, the principles discussed herein could apply to current, as well as voltage, mode bit lines and to different types of read/write memory cells including 4T and other SRAM cells.

Moreover, it should be appreciated that example sizes/models/values/ranges may have been given, although the present invention is not limited to the same. As manufacturing techniques (e.g., photolithography) mature over time, it is expected that devices of smaller size could be manufactured. With regard to description of any timing or programming signals, the terms “assertion” and “negation” are used in an intended generic sense. More particularly, such terms are used to avoid confusion when working with a mixture of “active-low” and “active-high” signals, and to represent the fact that the invention is not limited to the illustrated/described signals, but can be implemented with a total/partial reversal of any of the “active-low” and “active-high” signals by a simple change in logic. More specifically, the terms “assert” or “assertion” indicate that a signal is active independent of whether that level is represented by a high or low voltage, while the terms “negate” or “negation” indicate that a signal is inactive. In addition, well known power/ground connections to IC chips and other components may or may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A circuit, comprising:
SRAM having a plurality of cells organized into different groups; and
an ECC engine coupled to the SRAM to identify if one or more cells in a group is errant, wherein writeback for read operations is enabled for the groups with one or more errant cells and not enabled for other groups.

2. The circuit of claim 1, in which writeback is enabled for write operations for the groups with one or more errant cells.

3. The circuit of claim 1, in which the groups correspond to sub-arrays in a memory array, wherein each sub-array has columns of data cells and columns of ECC cells.

4. The circuit of claim 3, in which each sub-array has a writeback enable circuit to enable writeback if the sub-array has one or more errant cells.

5. The circuit of claim 3, in which the ECC engine processes the ECC data for sub-arrays not yet identified as having an errant bit upon a read operation for the sub-array.

6. The circuit of claim 1, in which the SRAM is cache memory in a processor chip.

7. A method, comprising:
reading data from a portion of SRAM; and
writing the data back into the read portion if it was determined by ECC during operation of the chip that the portion has one or more errant cells.

8. The method of claim 7, in which the portion corresponds to a wordline of cells.

9. The method of claim 8, in which the wordline of cells is grouped into sub-arrays, with each sub-array having a data section and an ECC section.

10. The method of claim 9, in which an ECC engine processes read ECC data from sub-arrays that have not been flagged as having an errant cell in order to determine if they have an errant cell.

11. The method of claim 10, in which the ECC engine causes a writeback enable flag to be set for a sub-array identified as having an errant cell.

12. A method, comprising:
upon a write operation to write new data into a sub-group from a group of SRAM cells on a wordline, reading data from the group of cells on the wordline;
writing the new data into the sub-group of cells and writing back the read data from the other cells of the group into their cells if one or more flags indicates that they have errant cells.

13. The method of claim 8, in which the sub-group corresponds to one or more sub-arrays each having a section of data cells and a section of ECC cells to indicate if one or more of the data cells is errant.

14. The method of claim 13, in which an ECC engine processes read ECC data from sub-arrays that have not been flagged as having an errant cell in order to determine if they have an errant cell.
